(19) United States
(12) Patent Application Publication
(10) Pub. No.: US 2005/0254083 A1
(43) Pub. Date: Nov. 17, 2005

(54) Document processing order management system, method for managing document processing orders, and software product for carring out the method

(76) Inventor: Jean-Marc Bodart, Louvain-la-Neuve (BE)

Correspondence Address: SCHIFF HARDIN, LLP;PATENT DEPARTMENT, 6600 SEARS TOWER, CHICAGO, IL, 60606-6473, US

(21) Appl. No.: 10/508,575

(22) PCT Filed: Mar. 17, 2003
(86) PCT No.: PCT/EP03/02757

§ 371 Date: Apr. 21, 2005

(30) Foreign Application Priority Data
Mar. 22, 2002 (DE) 102 12 890.1

(51) Int. Cl. G06F 15/00

(52) U.S. Cl. 358/1.15; 358/1.16

(57) ABSTRACT

A document processing order management system is provided which is linked via a data network with at least one computer system for generating document processing orders. The system includes: an input interface module for receiving document processing orders, a storage module for storing the incoming and the outgoing orders in a waiting queue, an output interface module for sending off the respective processing orders to respective document processing stations. The storage module is configured in such a manner that the sent-off document processing orders are automatically deleted from the document processing order management system only if a confirmation of the respective document processing station is received that the corresponding document processing order has been executed and finished.

### BACKGROUND OF THE INVENTION

1. Field of the Invention

The present invention relates to a document processing order management system that is connected, via a data network, with at least one computer system for producing document processing orders, and with a device for processing documents. In addition, the present invention relates to a method for managing document processing orders and a software product for carrying out such a method.

The present invention relates in particular to a print job management or control system for a data network that is connected with at least one computer system for producing print jobs and with a plurality of print sites, as well as a method for managing print jobs and a software product for carrying out such a method.

2. Description of the Related Art

Print job management systems, or document processing order management systems, for managing print jobs or document processing orders at a print site or document processing site are known. The term “print site” refers to an apparatus, installed at a particular location, having at least one print server and at least one printer connected with the print server, which is preferably a high-speed printer having a print capacity of more than 40 DIN A4 pages per minute, such as for example a printer, marketed by applicant, of the series DEMANDSTREAM 8000 web. If a print site comprises a plurality of print servers, they are connected with the data network via a single entry point. Such high-speed printers, which operate electrographically, can print a volume of one million to 30 million DIN A4 pages per month. The print sites are intended for professional use, and are standardly operated under the control of at least one operator.

A suitable print server for such a print site is the PRISMAproduction Server System of Océ Printing Systems GmbH, described for example in the publication “Das Druckerbuch [The Printer Book],” Gerd Goldmann, ed. 5a, October 2000, ISBN 3-00-001019-X, chapter 11. For the print job, such a print server takes over the tasks of spooling, print management, error handling, and accounting functions such as statistical evaluations, cost statement, and print tracking. The software of the PRISMApro Server System is formed from a plurality of modules. One of these modules is a Print Job Manager (PJM) that can produce print jobs. That is, for the print data job tickets are produced that contain the parameters required for the printing. In addition, the PJM can be used to monitor the status of the print jobs in the system.

As a rule, such print sites are connected with an intranet or with the Internet.

There is a significant need to distribute print jobs to a plurality of print sites distributed geographically at different locations. Thus, for example, in some telecommunications firms the bills for the telecommunications services are printed every month inside a time window of a few days. A print site having the capacity to execute all these print jobs would be immensely large and would be used only for a short time period. If it were possible to distribute the print jobs easily and reliably to a large number of existing print sites within the predetermined time window, then all print jobs could be executed in a timely fashion, and the geographically distributed print sites could be used for other print jobs the rest of the time.

From U.S. Pat. No. 5,287,194 B1, a “printshop management scheduling system” is known with which individual print jobs are distributed to different printers via a data network. The data of the respective connected printers are stored in a database of this system, so that when a print job is received the system can decide whether the printer is able to execute the print job. For this purpose, a spooling device fashioned independent of the printer is also queried, in which the print jobs are stored in queues for processing by the respective printer. With this query, it can be determined whether the incoming print job can be executed in the time required by the user. If the print job can be executed at the respective printer in the required time, it is stored in the corresponding queue, and a message is sent to the user stating the foreseen time of execution. If the print job cannot be executed under the required conditions, a corresponding message is sent to the user.

Such a system is suitable for managing print jobs within a print site at which several different printers are provided. For the management of print jobs that are to be communicated to print sites situated in a distributed fashion over a larger region, such a system is not suitable, because the individual controlling of the individual printers and the spooling of the print jobs for a multiplicity of printers in one system would become extraordinarily complex, and the coordination thereof would become very difficult if errors were to occur, for example during the print process. In particular, it is problematic if the user has already been told that the print job will be executed within a certain time, and then it turns out that this cannot be accomplished due to errors occurring at a printer at a remote location.

Similar systems are known under the trade names FlexServer, from the firm OPServer, and InfoPrint Manager, from the firm International Business Machines Corporation (IBM).

From U.S. Pat. No. 6,184,996 B1, a method is known for managing queues in which the job queue is controlled remotely via the Internet.

For sending print jobs over the Internet, in U.S. Pat. No. 6,219,151 B1 a method is described in which the print jobs are provided with the Internet address of the sender, and after the execution of the print job the printer sends a corresponding message to the sender.

From European Patent Document EP 1 150 200 A2, a device for managing a document processing order is known that forms part of a printer. This device is constructed in such a way that a document processing order that is to be printed in various formats and in various numbers of copies is held in the printer until it has actually been printed. Such print jobs are for example present when, for a presentation, transparencies are to be printed for a projector, and corresponding copies are to be printed on paper for the individuals attending the presentation. The printing on film and on paper can require different formats, and the printing on paper is also of multiple copies, as a rule.

From European Patent Document EP 0 653 700 B1, a network system is known in which one or more printers can be managed via a computer situated in a network. For this purpose, a control menu is provided with which various functions and the status of the printer are called and can be adjusted.

Thus, a multiplicity of different systems are known for the distribution of print jobs via a data network that intermediately store the print jobs in the network using a spooling device until the corresponding printer is ready to receive the print jobs, and then route the print jobs to the corresponding printer. There are systems that inform the user when an error has occurred. The user must then send the print job again. If the distribution of a large number of print jobs is to be carried out via a data network, such as for example several thousand print jobs within a few hours, these known systems are not suitable, because the spooling devices are too expensive and the error handling is too complex.

### SUMMARY OF THE INVENTION

The present invention is intended to create a document processing order management system that is suitable for the distribution of a large number of document processing orders to document processing sites situated in a geographically distributed manner, and to ensure in a simple manner the reliable execution of the document processing orders.

This is achieved by a document processing order management system connected via a data network with at least one computer system for producing document processing orders and with a plurality of document processing sites, including a front-end module for receiving document processing orders, a storage module for storing the incoming and outgoing jobs in a queue, a back-end module for sending off each processing order to a respective document processing site, said storage module being fashioned such that the sent-off document processing orders are deleted automatically by the document processing order management system only if a confirmation has been received from the respective document processing site stating that the corresponding document processing order has been completely executed.

The invention in a further embodiment provides a document processing order management system for a data network connected with at least one computer system for producing document processing orders and with a plurality of document processing sites, including a front-end module for receiving document processing orders, a storage module for storing the incoming and outgoing document processing orders in a queue, a back-end module for sending off each document processing order to one of the document processing sites, said the document processing order management system including a plurality of logical input destinations, to which a document processing order can be sent by a computer system for producing document processing orders, and the document processing order management system comprises for each controllable document processing site at least one logical output destination, whereby a logical output destination is allocated to each logical input destination in such a manner that the incoming document processing orders for a particular logical input destination are routed automatically to the document processing site of the allocated logical output destination.

In a further embodiment, the invention provides a method for managing document processing orders by a document processing order management system that is situated in a data network and that has at least one computer system for producing document processing orders and a plurality of document processing sites, including the steps of: receiving of document processing orders, storing of the incoming and outgoing document processing orders in a queue in a storage module, sending off of each document processing order to a respective document processing site, automatically deleting the sent-off document processing orders by the document processing order management system only if a confirmation has been received from the respective document processing site stating that the corresponding document processing order has been printed.

A method is also provided for managing print jobs by means of a print job management system that is situated in a data network and that has at least one computer system for producing print jobs and a plurality of print sites, including the steps of: receiving of print jobs, storing of the incoming and outgoing print jobs in a queue in a print job buffer, sending off of each print job to a respective print site, whereby the print job management system comprises a plurality of logical input destinations to which a print job can be sent by a computer system for producing print jobs, and the print job management system comprises, for each controllable print site, at least one logical output destination, whereby a logical output destination is allocated to each logical input destination in such a way that the incoming print jobs for a particular logical input destination are routed automatically to the print site of the allocated logical output destination.

The document processing order management system including a plurality of logical input destinations, to which a document processing order can be sent by a computer system for producing document processing orders, and the document processing order management system comprises for each controllable document processing site at least one logical output destination, whereby a logical output destination is allocated to each logical input destination in such a manner that the incoming document processing orders for a particular logical input destination are routed automatically to the document processing site of the allocated logical output destination.

The document processing order management system for a data network according to the present invention is connected to at least one computer system for the production of document processing orders and to a plurality of document processing sites, and includes a front-end for receiving document processing orders, a storage module for storing the incoming and outgoing document processing jobs in a queue, and a back-end for sending off the respective document processing jobs to a respective document processing site.

This document processing job management system is distinguished in that the storage module is fashioned in such a way that the sent-off document processing orders are stored until a confirmation is received from the respective document processing site that the corresponding document processing order has been printed. A document processing order is thus deleted automatically only if a confirmation of the successful execution of the document processing order has been received.

The holding of the document processing orders until a corresponding confirmation has been received from the document processing site ensures in a very simple manner that the document processing order does not get lost in the data network, even if an error should occur at the respective document processing site and the document processing order is not printed out and is destroyed immediately in the document processing site. By keeping a copy of the document processing order in the document processing order management system, the document processing order can be routed again to a document processing site. The operator of the document processing order management system can however manually delete a document processing order if it is no longer to be printed.

A further advantageous document processing order management system is distinguished in that the document processing order management system comprises a plurality of logical input destinations or addresses to which a document processing order can be sent by a computer system for the production of document processing orders, and comprises at least one logical output destination for each controllable document processing site, whereby a logical output destination is allocated to each logical input destination in such a manner that the incoming document processing orders for a particular logical input destination are automatically routed to the document processing site of the allocated logical output destination.

The document processing order management systems explained above are preferably print job management systems, and the document processing sites are preferably print sites that can execute print jobs.

The user of a computer system for producing print jobs can select at his computer system an input destination to which he sends his print jobs. These jobs are then automatically routed to a print site by the print job management system according to the present invention. The operator of the print job management system can determine the distribution of the print jobs to various print sites by determining the allocation of the output destinations to the input destinations, and can thus bring about a uniform loading of the individual print sites. The individual user who produces the print jobs, designated “producer” in the following, has as a rule no detailed knowledge of the individual print sites, so that he is not able to distribute the print jobs to a plurality of print sites in a suitable manner. With the present invention, a print job management system is created that makes possible central management of the distribution of the print jobs over several regions, whereby the inventive print job management system requires only one operator, who changes the allocation between the input and output destinations as required. The producer knows only the input destinations, which can if necessary contain information concerning the controlled print site or the controlled printer, while the manner in which the routing of the print jobs by means of the inventive print job management system takes place remains hidden, because it is executed automatically.

### BRIEF DESCRIPTION OF THE DRAWINGS

Additional exemplary embodiments of the present invention are explained in more detail below on the basis of drawings.

FIG. 1 is a schematic diagram of a data network having a print job management system according to the present invention;

FIG. 2 is a schematic diagram of the components of a print job management system according to the present invention;

FIG. 3 shows the inventive method in a flow diagram;

FIG. 4 to FIG. 12 each show a graphic user interface of a computer program for the execution of the inventive method in different operating states;

FIG. 13 shows the commands for executing a print job in a table;

FIG. 14 shows state values of the print jobs in a table;

FIG. 15 shows some essential commands from FIG. 13 and the connection with the state values from FIG. 14, in the form of a table; and

FIG. 16 shows substrate values of the print jobs in a table.

### DETAILED DESCRIPTION OF THE PREFERRED EMBODIMENTS

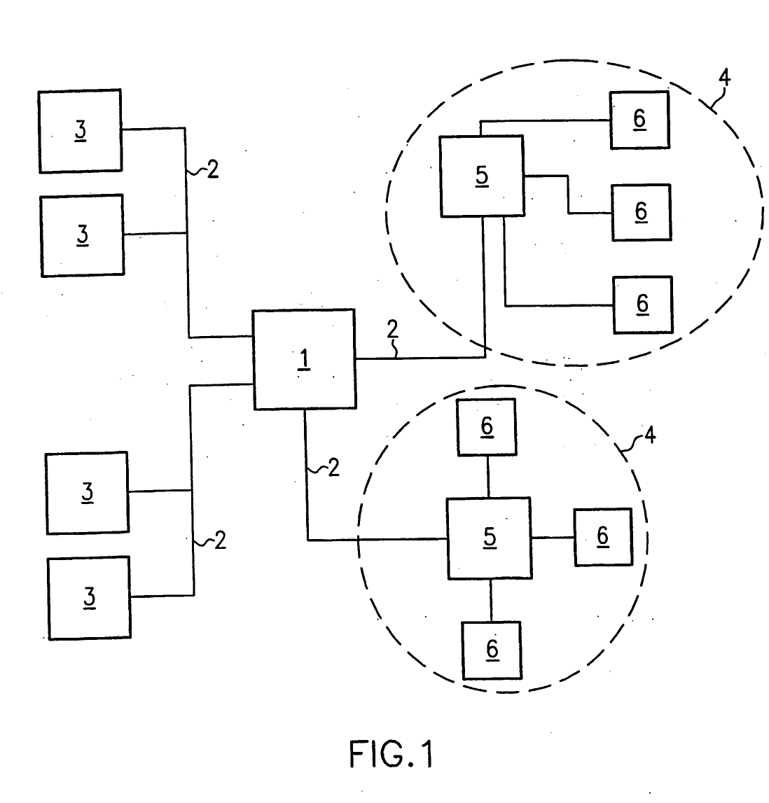

FIG. 1 shows a schematic diagram of a print job management system 1 according to the present invention that is connected, via a data network 2, with computer systems 3 for producing print jobs, known as clients, and also with print sites 4. Print sites 4 each comprise a print server 5 and one or more printers 6.

As a rule, the data network is a wide area network (WAN), such as for example the Internet or a wide area intranet, and is shown schematically in FIG. 1 by corresponding data lines 2. However, it can also be a local area network (LAN). Such an application can for example be useful in large companies that have a plurality of print sites and in which particular print jobs are to be distributed centrally to the print sites.

Computer systems 3 for producing print jobs are as a rule personal computers connected to data network 2, on which there is installed a graphics program or word processing program for producing print data files. In the present exemplary embodiment, the individual computer systems 3 are PRISMAproduction clients, as described in “Das Druckerbuch,” Gerd Goldmann, ed. 5a, October 2000, ISBN 3-00-001019-X. For the data file, these PRISMAproduction clients produce a job ticket, which tickets together represent the print job and are routed to print job management system 1 according to the present invention.

Print job management system 1 routes the print jobs to the individual print sites 4 via data network 2. In the present exemplary embodiment, each print server 5 of print sites 4 is a PRISMA production server, as described above.

In the following specification, for the individual method steps the English expressions used by the inventors are indicated in brackets. In the drawings, which are partly copies of display screen representations, the corresponding English terms are to be found. A glossary is appended containing the corresponding German and English terms.

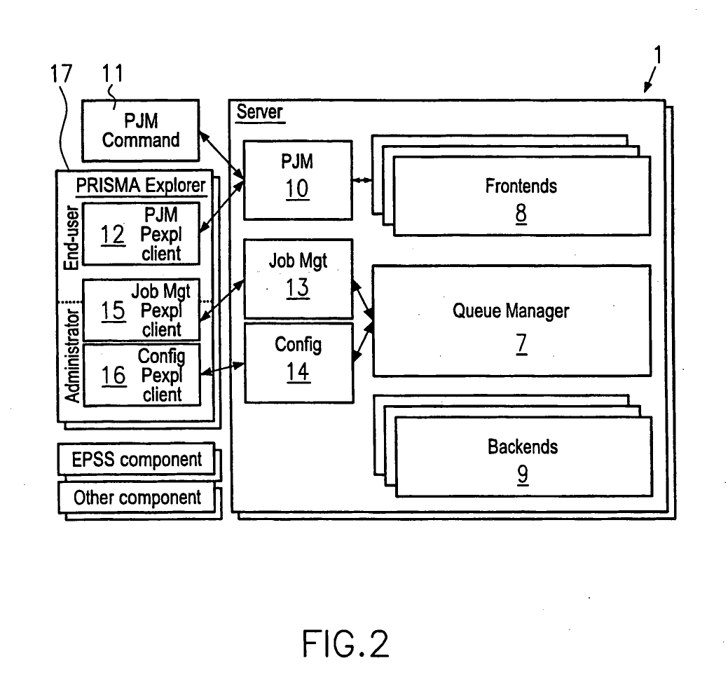

FIG. 2 shows, as an example, the software modules of print job management system 1 according to the present invention. Print job management system 1 according to the present invention represents in data network 2 a server that operates for example with a UNIX operating system. The essential software modules of print job management system 1 are a storage module (queue manager) for storing the print jobs in a queue, a front-end module 8 and a back-end module 9. Preferably, a plurality of front-end modules 8 and a plurality of back-end modules 9 are provided, each configured for the reception or for the sending of print jobs having a particular format (for example, AFP, PCL, PostScript, PDF, TIF, LCDS) and/or for transmission using a particular data transmission protocol (for example, PSF host download, FTP, lpd, . . . ). Preferably, corresponding back-end modules 9 are provided for particular printer types.

Front-ends 8 are provided with a user interface 10, at which either commands can be entered directly for the management of the print jobs (PJM command 11; PJM=Print Job Manager) or a graphic interface 12 is provided for the inputting of such commands.

Storage module 7 is provided with two user interfaces 13 and 14 for organizing the print jobs (job management), or for configuring the print job management system. These user interfaces 13 and 14 are each coupled to corresponding graphic panels 15 and 16. In the present exemplary embodiment, the graphic operating panels 12, 15 and 16 are represented by a software product under the trade name PRISMA Explorer 17 of Océ Printing Systems GmbH.

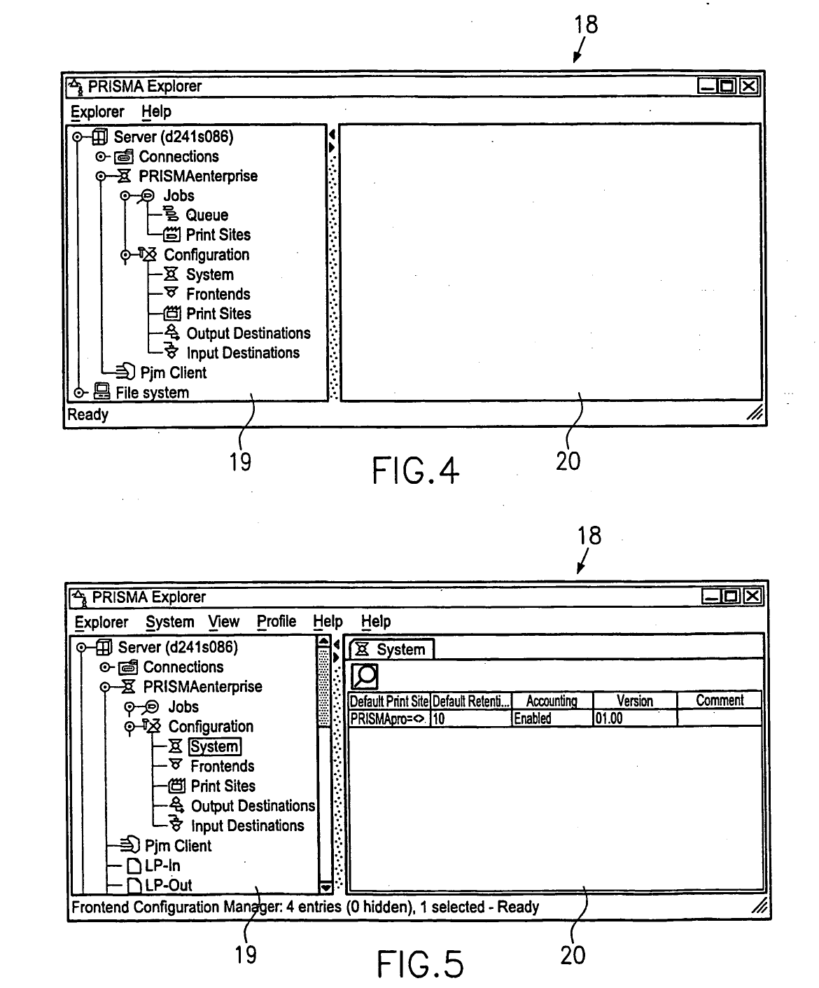

In the following, the configuration of front-ends, print sites, logical output destinations, and logical input destinations is explained on the basis of screen shots (FIG. 4-9).

The software product PRISMAexplorer produces a window 18 that is divided into a left section 19 and a right section 20. In the left section, the individual objects are displayed in a directory, whereby the objects relevant for the inventive print job management system are listed under the directory PRISMAenterprise. Here, two subdirectories are provided, designated Jobs and Configuration. In the Configuration subdirectory, the objects are listed that are to be configured by an administrator of the inventive print job management system, namely the system (System), front-end modules (Front-ends), print sites (Print Sites), logical output destinations (Output Destinations), and logical input destinations (Input Destinations). In the subdirectory Jobs, the objects queue (Queue) and print sites (Print Sites) are listed that can be processed by the administrator or the operator of the inventive print job management system during operation.

In order to configure an object, the corresponding object is clicked in the last section 19 of window 18. In FIG. 5, the object System has been selected and clicked, so that in the right section 20 of the window the corresponding data describing the system are shown in tabular form.

For the configuration of the front-ends, in PRISMA Explorer 17, in the Configuration directory, the front-ends are clicked, whereby in PRISMA Explorer a corresponding table is shown with the existing front-ends 8. In the present exemplary embodiment, four front-ends are present, designated “Front-end Download,” “Front-end HotDir,” “Front-end LP,” and “Front-end Pjm.” The individual front-end modules 8 can receive print jobs in accordance with different protocols (host download from MVS hosts, FTP using the Hot Directory front-end, LP from UNIX and Windows clients, PJM from the PRISMA job manager interface (PRISMA Explorer), and PJM input lines). In addition, in the table the corresponding type of the front-end modules 8, as well as their state (active/inactive) is indicated. The table also indicates whether the individual front-end modules are automatically activated when the print job management system is started up (Automatic Activation). In the present case, this function is activated (Enabled) for all front-end modules. In addition, a comment (Comment) can also be entered in the table. Using this table, new front-end modules can be added, or existing ones can be deleted, or their state and function can be modified.

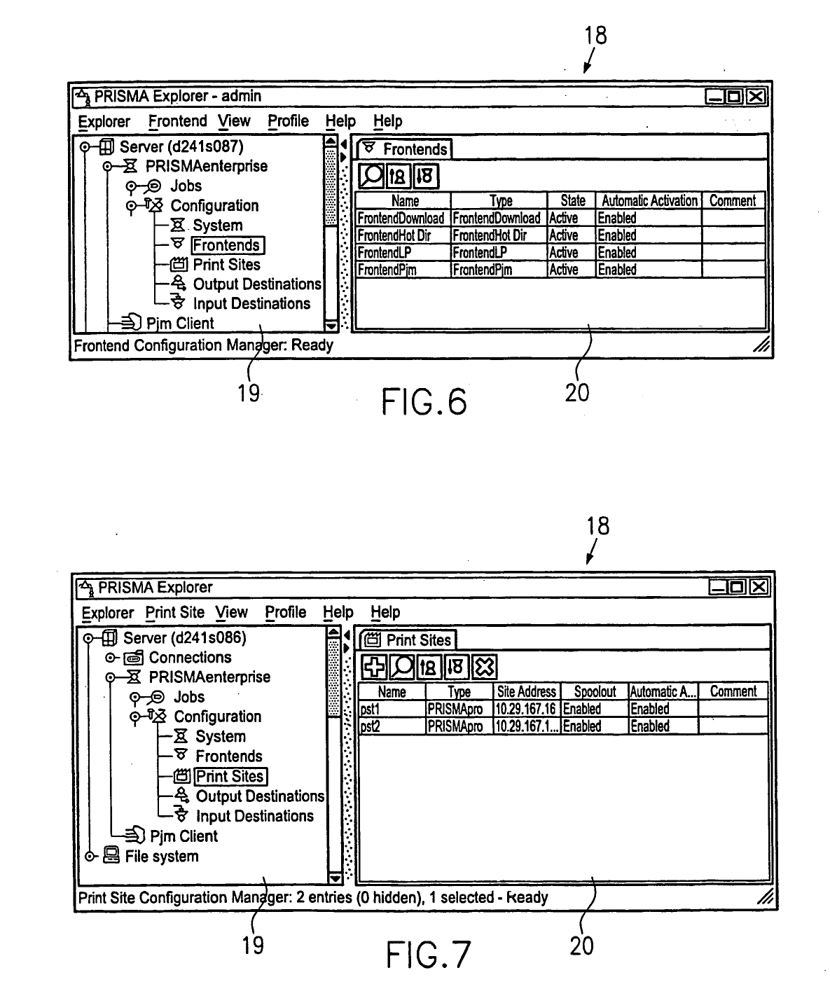

The print sites can be configured in a similar manner (FIG. 7). For this purpose, in PRISMAexplorer the print sites are clicked, and a table similar to that in FIG. 6 appears, containing the name of the print site, the type of the print site, its address, and additional functions (spool out, automatic activation, comment). In the exemplary embodiment shown, the print sites are named “pst1” and “pst2.” They are each of the type PRISMApro. The indication of the type represents the coupling to the corresponding back-end module 9. Its address is an IP address in numeric format, or the domain name of the print site. If the spoolout function is activated (Enabled), the communication to the print site is enabled, so that the print job management system can route a print job to the corresponding print site. If this function is deactivated (disabled), the communication to the print site is interrupted.

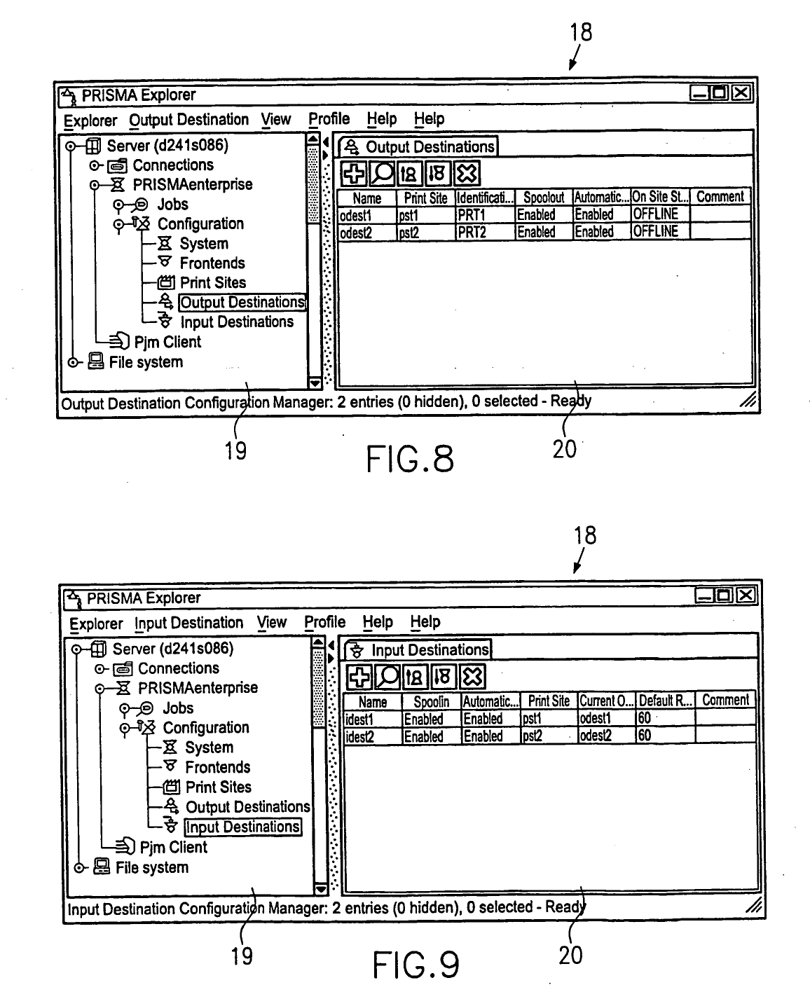

FIG. 8 shows the corresponding table for configuring the logical back-ends or output interfaces (Output Destinations). This table includes the names of the logical back-end, the allocated print site, an identification for the print site, and additional functions (Spoolout, Automatic Activation, On Site State, Comment). The two logical back-ends shown in FIG. 8 are designated “odest1” and “odest2.” Print sites pst1 or pst2 are respectively allocated to them, and in the print sites a printer designated “PRT1” and “PRT2” is driven, whose designation is contained in the identification for the print site in the table. With the spoolout function, the allocation to the print site and to the corresponding back-end module is activated or deactivated. In addition, the status at the print site “On Site State” is indicated, which in the present case is “OFFLINE.” Relative to circumstances, the status can also be “ONLINE,” “PRINTING,” etc.

With these logical back-ends, all parameters and allocations for transmitting the print jobs from the print job management system to a print site are determined.

FIG. 9 shows the window for configuring the logical input destinations (Input Destinations), whereby a corresponding table again indicates the name of the logical input destinations, the current logical output destinations (Current Output Destination), the print site, and additional functions (Spoolin, Automatic Activation, Default Retention Period). In the present exemplary embodiment, two logical input destinations are provided with the designations “idest1” and “idest2.” If the function “Spoolin” is activated (Enabled), this input destination is enabled for the reception of printed jobs. A very important indication in this table is the current logical output destination (Current Output Destination), because this determines the allocation of a particular logical output destination to the logical input destination. The incoming print jobs for a logical input destination are hereby automatically routed to the print site allocated to the logical output destination. The table also indicates the corresponding print site, whereby this value results automatically due to the inputting of the current logical output destination.

The table also contains an indication of the duration of the retention period (Default Retention Period), given in minutes. The retention period is the time during which a print job is stored in the inventive print job management system after it has already been completely executed at the print site. This retention period is used to initiate possible additional copies of the print job.

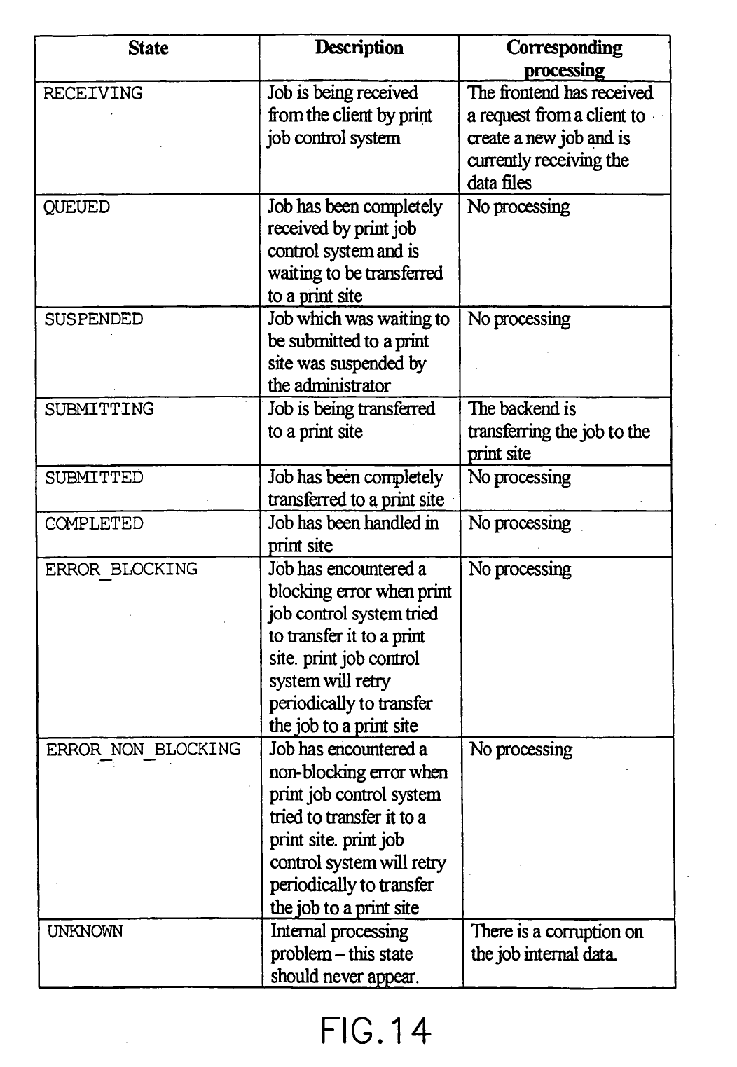

If the front-end modules, print sites, logical output destinations, and logical input destinations are configured, the incoming print jobs for the logical input destinations are intermediately stored automatically in storage module 7, and are routed to the allocated logical output destinations via back-end modules 9, in a manner corresponding to the indications. For this purpose, a state value is allocated to each of the individual print jobs. The possible state values are listed in the table shown in FIG. 14, with their respective description and the associated processes. The state values comprise the following values: RECEIVING, QUEUED, SUSPENDED, SUBMITTING, SUBMITTED, COMPLETED, ERROR_BLOCKING, ERROR_NON_BLOCKING, UNKNOWN.

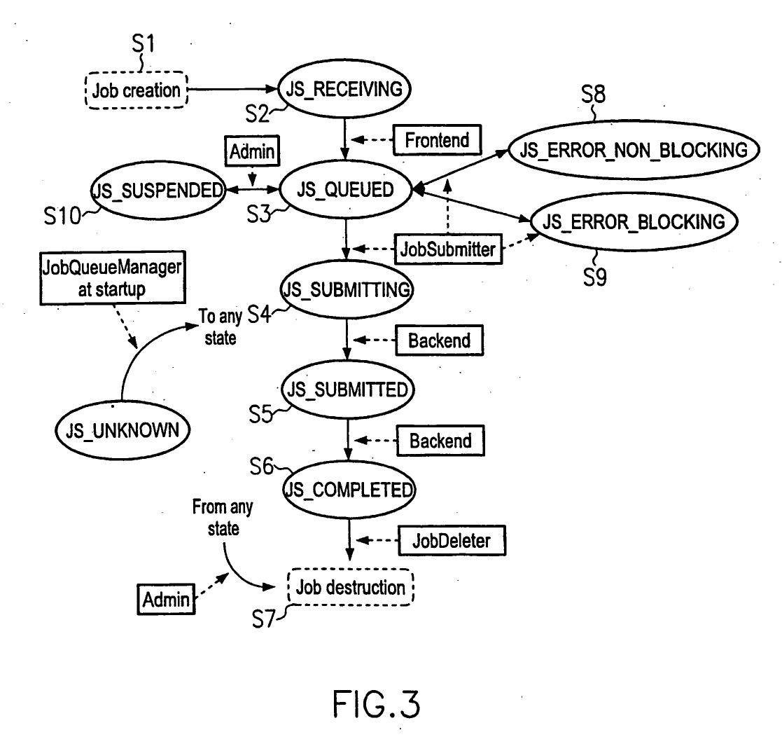

In the following, the sequence of the receiving, storing, and routing of the print jobs is explained on the basis of the flow diagram shown in FIG. 3. First, in step S1 a print job is produced at a computer system for the production of print jobs (Client) and is transmitted to print job management system 1 via data network 2, whereby the print job is sent from the producer to one of the logical input destinations predetermined by print job management system 1. During the receiving of the print job by one of the front-end modules 8, the status value of the print job is set to Receiving (S2). This means that the corresponding front-end module 8 has received from the client a request for the transmission of the data of the print job, and the corresponding data files are currently being received. If the data files have been completely received, they are stored in a queue, and the corresponding print status is set to Queued (S3). The print job remains in the queue until it can be sent to the print site predetermined by the logical output destination.

When it is time for this print job to be sent, it is sent to the corresponding print site 4 via data network 2, whereby the status value of the print job is set to Submitting (S4) in print job management system 1. If the print job has been completely transmitted by means of one of the back-end modules 9, the status value is set to Submitted (S5). The print job is still held completely in storage module 7 even if it has already been completely transmitted to print site 4.

The print job management system queries the corresponding print sites 4 at regular intervals as to whether the print jobs sent to them have been executed. If this query yields the result that the print job has been completely executed, the state value of the print job is set to Completed (S6).

Instead of a query at regular intervals as to whether the print jobs have been completely executed, the print sites can send corresponding messages to the print job management system, informing the system that a print job has been completed (event management).

The print job is held by storage module 7 for the predetermined retention period after the setting of the status value to Completed. During this time, the operator or administrator of the print job management system can initiate the production of an additional printing of this print job. If this retention period has elapsed, the print job is deleted in step S7.

If an error occurs during the transmission to a print site, the status value is set to ERROR_NON_BLOCKING if a non-blocking error has occurred, or to ERROR_BLOCKING (S8, S9) if a blocking error has occurred. The print job is placed in the queue again at a suitable point in time, by setting the status value to Queued, and an attempt is made again in step S4 to send it to the print site.

The print jobs in the queue can be suspended by the operator or administrator of the print job management system, whereby the status value is set to Suspended (S10).

The administrator or operator can delete a print job at any time, no matter what its status is.

If print jobs are stored in the print job management system before the system has been started up, they are allocated the status value Unknown during the starting up of the system. This status value is also allocated to print jobs if there is claimed to be an internal problem that actually cannot occur.

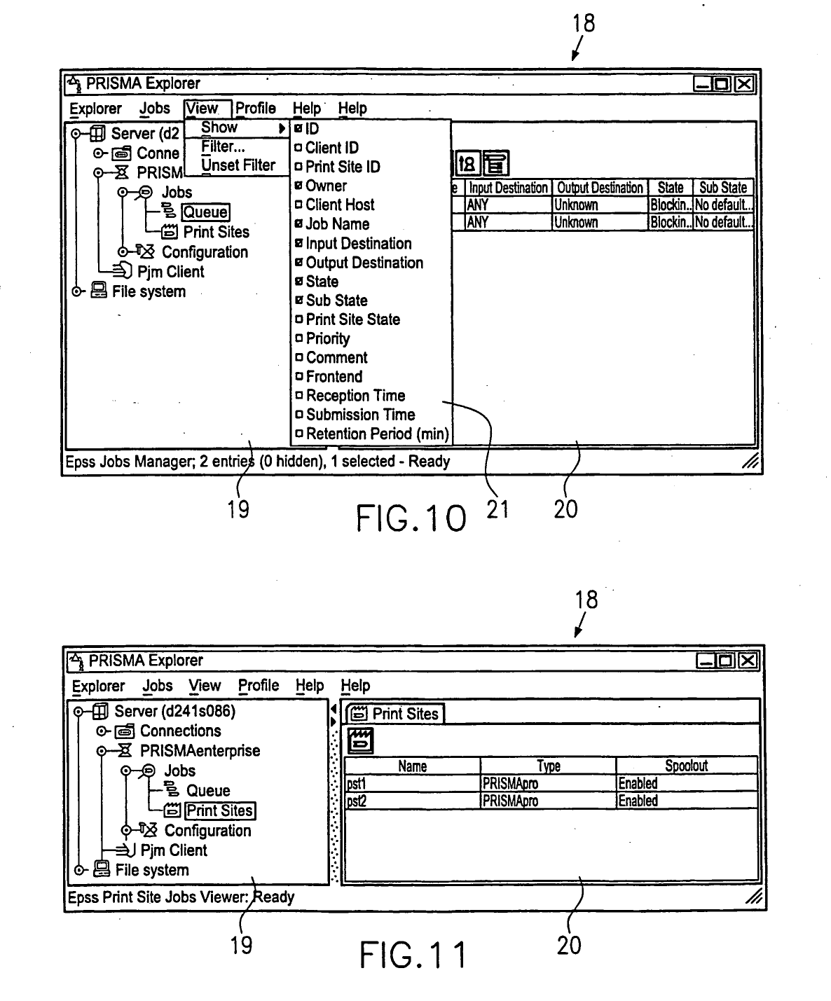

During operation, the user can on the one hand monitor the print jobs that have been received by the inventive print job management system and that are to be routed, and can also intervene actively in the routing process. This is explained in the following on the basis of the screen representations shown in FIGS. 10-12.

FIG. 10 shows window 18, whereby the object Queue in the Jobs directory has been clicked, and in a menu bar located [in] window 18 the menu point “View” with submenu point “Show” has been selected. This opens a subwindow 21, in which the individual parameters can be determined that are shown in the table in the right section 20 of window 18. In this way, the user can freely select the parameters to be monitored by him, and can determine them using these menu points. The parameters of the print sites, shown in the table in the right section 20 of window 18, are designed in a corresponding manner (FIG. 11). This submenu point “Show” also exists in all the other configurable objects.

The producer of the print data file can call the data displayed in the table from FIG. 10 on his computer system 3, whereby, however, he has access only to the data of his print job. If the output destination has been defined, he can for example find out where his print job is being printed.

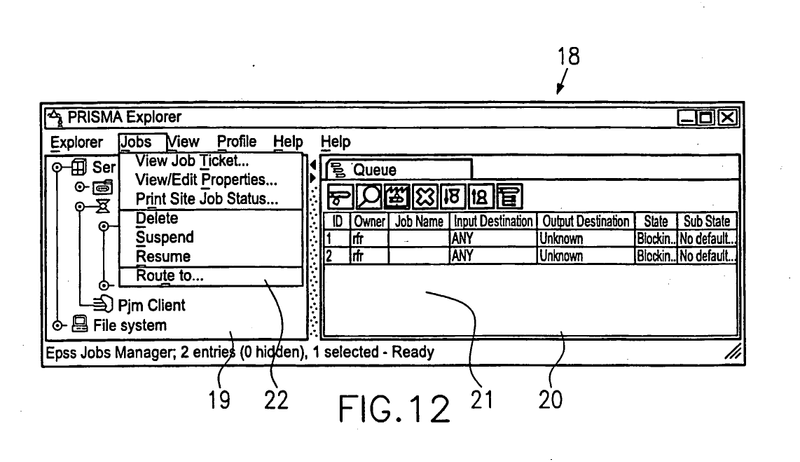

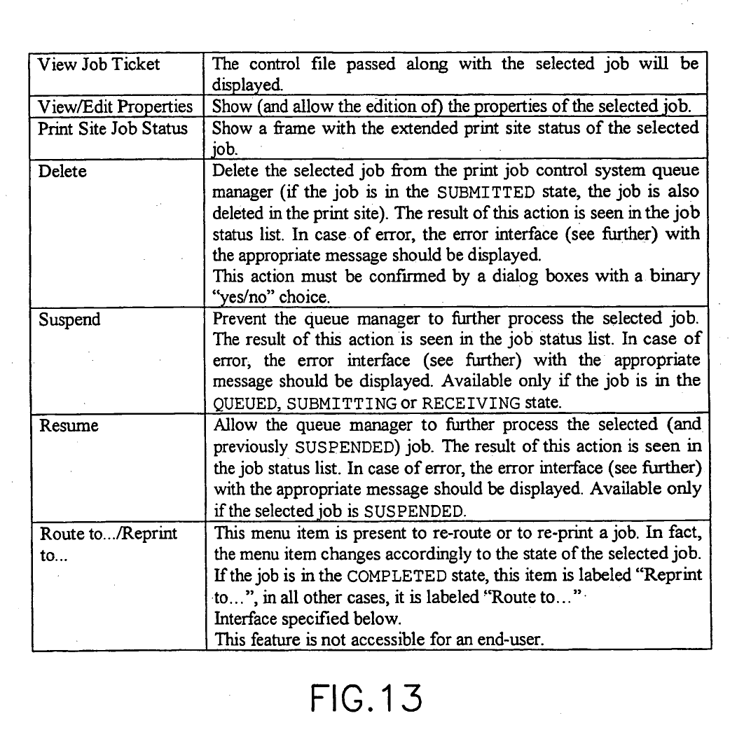

FIG. 12 shows window 18, whereby the object Queue has again been clicked in the Jobs directory. In addition, in the menu line the menu point Jobs has been selected, in which the following commands are listed in a subwindow 22:
View Job Ticket
View/Edit Properties
Print Site Job Status
Delete
Suspend
Resume
Route to . . . /Reprint to . . .

With the command “View Job Ticket,” this part of the job ticket is shown in a corresponding window.

With the command “View/Edit Properties,” individual properties of a selected print job can be viewed and edited.

With the command “Print Site Job Status,” the status is shown of the print site at which a selected print job is being printed or is to be printed.

With the command “Delete,” individual print jobs in the queue can be deleted.

With the command “Suspend,” individual print jobs can be suspended, as long as their state value is QUEUED, SUBMITTING, RECEIVING, ERROR_BLOCKING, or ERROR_NON_BLOCKING.

With the command “Resume,” suspended print jobs can be resumed, so that they are added to the queue for transmission to the corresponding print site. This is carried out by changing the state value from SUSPENDED to QUEUED.

With the command “Route to . . . /Reprint to . . . ,” a print job can be routed either to a different print site, if it has not yet been executed, or can be routed again to the print site if it has already been completely printed and the status value is COMPLETED.

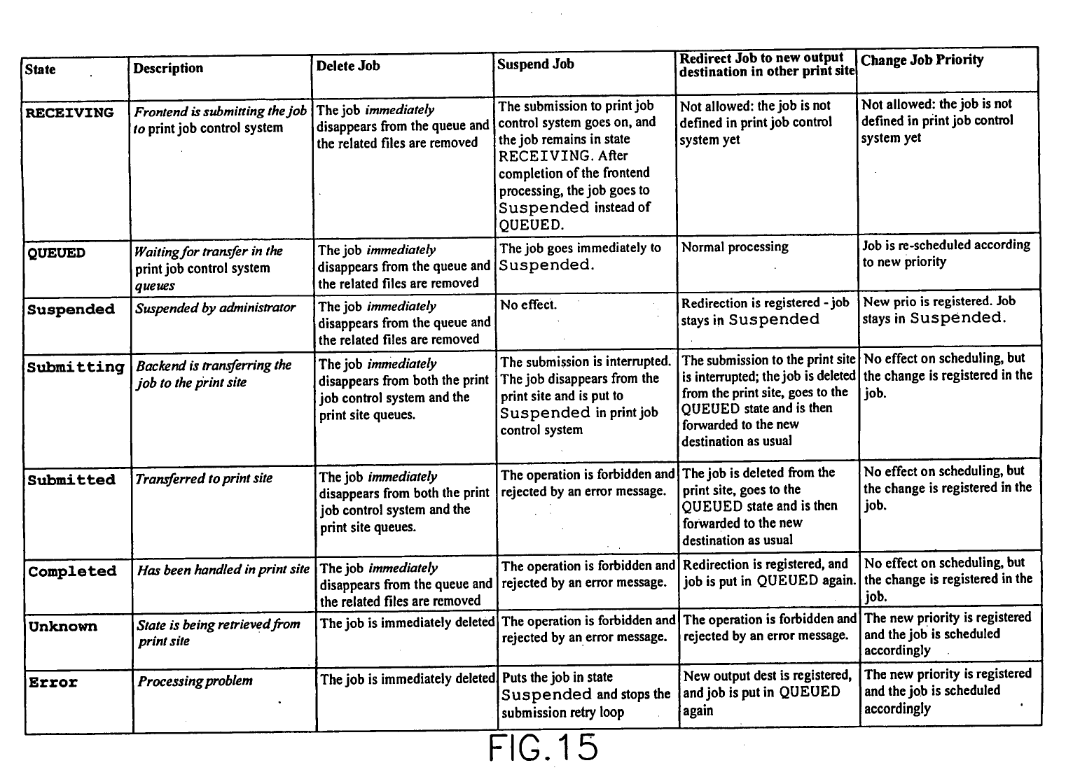

FIG. 15 shows a table in which one of the commands is allocated to each column and in which each line is allocated to a status value of a print job. This table indicates how the corresponding print job is processed when one of the commands is called and it is in the corresponding state.

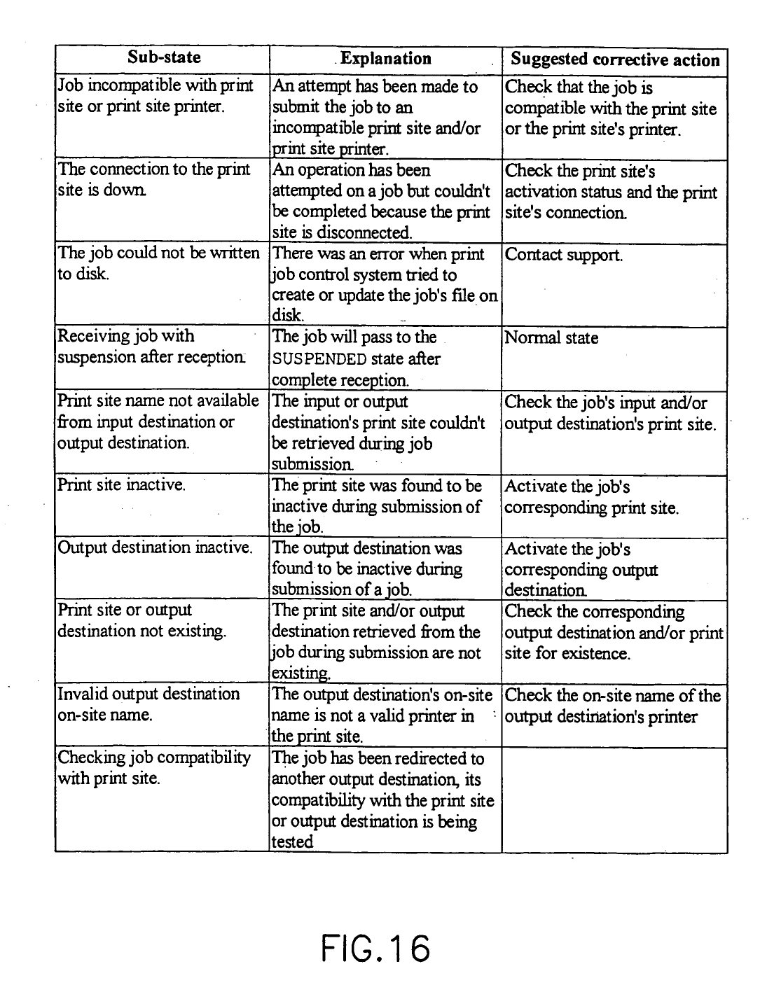

The table shown in FIG. 16 shows in the first column a list of substrate values, with explanation (second column) and proposed corrections (third column).

These substrate values describe particular errors.

These errors are:
the print job is not compatible with the print site or with the printer at the print site,
the connection to the print site has been interrupted,
the print job cannot be written to the hard drive,
the print job is being received and will be suspended after the completion of reception,
the name of the print site cannot be obtained on the basis of the logical input destination or the logical output destination,
the print site is inactive,
the logical output destination is inactive,
the print site or the logical output destination do not exist,
the name referring to the print site is not valid for the logical output destination,
the compatibility of the print job with the print site is being checked.

These substrate values are used for the handling of standard errors or problems in the operation of the print job management system.

With the inventive print job management system, in a data network print jobs can be transmitted to different clients in different formats and using different protocols, can be received in bundled fashion at a site, and from there can be distributed to a plurality of print sites. In this system, on the one hand the print jobs can be held until they have been executed completely at the corresponding print site, and on the other hand the routing of the print jobs takes place as determined by the administrator or operator of the print job management system, so that the user at the client need only select a logical input destination; the problems of distribution are then taken over by the operator. A user at the client will know nothing more about what takes place downstream at the print job management system. Of these processes, he is informed only that his completely printed print job has been received, or requests the data shown in FIG. 10. If the print job is rerouted from one print site to a different print site by the operator of the print job management system, it is useful for the operator to inform the producer of the print job accordingly. For large print jobs, it can be useful to reroute a print job to a remotely situated print site and for the operator simultaneously to place a forwarding order for the transporting of the printed documents to the location at which they have been requested or at which they are required.

Although the present invention in the exemplary embodiments has been described on the basis of a print job management system for a data network, it can also be applied to other systems for the processing of documents. For example, documents can be subjected to post-processing steps in addition to printing, such as for example mechanical cutting, binding, or collation with other documents, in particular printed ones, such as full-color printed documents or documents having particular security markings. In addition, the documents can also be processed purely electronically at various distributed locations, for example in the conversion of documents that, that are in a page description language, such as for example the language Advanced Function Presentation (AFP) or PostScript or Page Code Language (PCL), and are to be converted into rasterized data in a rastering process. In addition, the method can be used for the decentralized processing of larger quantities of data files (e.g., e-mails), by distributing the data files in decentralized fashion via an internal fast network, and then routing them into slower external networks.

In conclusion, it is again noted:

The present invention relates in particular to a print job management system for a data network, a method for managing print jobs, and a software product for executing such a method.

With the present invention, in particular print jobs in a data network can be received at a central location and can be distributed from there to regionally distributed print sites. The producer of a print data file thereby selects only a logical input destination of an inventive print job management system, and the print job is then routed automatically to a print site. According to a further aspect of the present invention, the print job is held at the print job management system until the print job has been completely executed at the print site.

Although other modifications and changes may be suggested by those skilled in the art, it is the intention of the inventors to embody within the patent warranted hereon all changes and modifications as reasonably and properly come within the scope of their contribution to the art.

1-18. (canceled)

19. A document processing order management system connected via a data network with at least one computer system for producing document processing orders and with a plurality of document processing sites, comprising:
a front-end module for receiving document processing orders,
a storage module for storing incoming and outgoing jobs in a queue,
a back-end module for sending off each processing order to a respective document processing site,
said storage module being fashioned such that sent-off document processing orders are deleted automatically by the document processing order management system only if a confirmation has been received from a respective document processing site stating that the corresponding document processing order has been completely executed.

20. A document processing order management system for a data network connected with at least one computer system for producing document processing orders and with a plurality of document processing sites comprising:
a front-end module for receiving document processing orders;
a storage module for storing incoming and outgoing document processing orders in a queue;
a back-end module for sending off each document processing order to one of the document processing sites;
said document processing order management system including a plurality of logical input destinations to which a document processing order can be sent by a computer system for producing document processing orders, and
said document processing order management system including for each controllable document processing site at least one logical output destination, wherein a logical output destination is allocated to each logical input destination in such a manner that the incoming document processing orders for a particular logical input destination are routed automatically to the document processing site of the allocated logical output destination.

21. A document processing order management system as recited in claim 19, wherein said document processing order management system is fashioned as a print job management system for a data network, said document processing sites are print sites and the document processing order is a print job.

22. A document processing order management system as recited in claim 20, wherein the allocation between the logical input destinations and the logical output destinations can be modified by an operator at the document processing order management system.

23. A document processing order management system as recited in claim 20, wherein one of the logical output destinations is allocated to a particular printer at one of the print sites.

24. A document processing order management system as recited in claim 19, wherein the document processing order management system is a network server on which the front-end module and the storage module and the back-end module are installed as software modules.

25. A document processing order management system as recited in claim 19, wherein the document processing order management system is fashioned for the receiving and routing of print jobs in at least one of the formats AFP, PCL, PostScript, PDF, TIFF, and LCDS.

26. A document processing order management system as recited in claim 19, wherein a plurality of front-end modules are provided for receiving document processing orders using a predetermined data transmission protocol.

27. A document processing order management system as claimed in claim 26, wherein said predetermined data transmission protocol is selected from the group consisting of: lpd, PSF, Host Download, FTP, PJM, and IPP.

28. A document processing order management system as recited in claim 19, wherein a plurality of back-end modules are provided for sending off print jobs for a particular printer type with a predetermined data transmission protocol.

29. A document processing order management system as claimed in claim 28, wherein said printer types is selected from the group consisting of: PRISMAproduction Back-end, PRISMAoffice Back-end, InfoPrint Back-end, and DocExec Back-end.

30. A document processing order management system as recited in claim 20, wherein the document processing sites are situated at various geographical locations, and each including at least one print server.

31. A document processing order management system as claimed in claim 30, wherein at least one of said document processing sites includes a plurality of printers.

32. A method for managing document processing orders by a document processing order management system that is situated in a data network and that has at least one computer system for producing document processing orders and a plurality of document processing sites, comprising the steps of:
receiving document processing orders;
storing incoming and outgoing document processing orders in a queue in a storage module;
sending off of each document processing order to a respective document processing site; and
automatically deleting sent-off document processing orders by the document processing order management system only if a confirmation has been received from the respective document processing site stating that the corresponding document processing order has been printed.

33. A method for managing print jobs by a print job management system that is situated in a data network and that has at least one computer system for producing print jobs and a plurality of print sites, comprising the steps of:
receiving print jobs;
storing incoming and outgoing print jobs in a queue in a storage module;
sending off of each print job to a respective print site; and
automatically deleting the sent-off print jobs by the print job management system only if a confirmation has been received from the respective print site stating that the corresponding print job has been printed.

34. A method for managing print jobs by means of a print job management system that is situated in a data network and that has at least one computer system for producing print jobs and a plurality of print sites, comprising the steps of:
receiving of print jobs;
storing of the incoming and outgoing print jobs in a queue in a print job buffer;
sending off of each print job to a respective print site,
wherein the print job management system comprises a plurality of logical input destinations to which a print job can be sent by a computer system for producing print jobs, and the print job management system comprises, for each controllable print site, at least one logical output destination, whereby a logical output destination is allocated to each logical input destination in such a way that the incoming print jobs for a particular logical input destination are routed automatically to the print site of the allocated logical output destination.

35. A method as recited in claim 34, further comprising the steps of:
allocating a state value to each print job that describes at least whether the respective print job has been transmitted to a printer or whether the print job printing has been completed by one of the print sites.

36. A method as recited in claim 35, wherein the print job management system queries the print sites at determined time intervals as to whether the print jobs sent to the print sites have been executed, and, if the result of the query is that the respective print job has been executed, the state value is set to completed

37. A method as recited in claim 36, wherein after the state value has been set to completed, the print jobs are held for a particular time duration and are then deleted.

38. A method as recited in claim 35, wherein the state value additionally describes whether the respective print job has been received (receiving), is situated in the queue (queued), has been suspended (suspended), is being sent to the print site (submitting), or contains an error (error).

39. A software product for executing a method for managing document processing orders by a document processing order management system that is situated in a data network and that has at least one computer system for producing document processing orders and a plurality of document processing sites, comprising:
a software module for receiving orders,
a software module for storing the incoming and outgoing orders in a queue in an order buffer, and
a software module for sending off each order to at least one of a respective document processing site and a print site.
